(19) United States
(12) Patent Application Publication
(10) Pub. No.: US 2010/0145888 A1
(43) Pub. Date: Jun. 10, 2010

(54) SPONSORSHIP METHOD

(76) Inventor: Steven N. Verona, Philadelphia, PA (US)

Correspondence Address: KREMBLAS, FOSTER, PHILLIPS & POLLICK, 7632 SLATE RIDGE BOULEVARD, REYNOLDSBURG, OH, 43068, US

(21) Appl. No.: 12/634,228

(22) Filed: Dec. 9, 2009

Related U.S. Application Data
(60) Provisional application No. 61/120,949, filed on Dec. 9, 2008.

(51) Int. Cl. G06Q 90/00

(52) U.S. Cl. 705/500

(57) ABSTRACT

A method of rewarding sponsored individuals after they obtain public exposure for their sponsor's trademark or other indicia. The indicia are placed on the individual's person, such as his or her clothing, vehicle or equipment, and publicity is gained. Evidence of the public exposure is communicated to the sponsor, or the proper management agent, for verification and disbursement of the fee. The communicating step can be carried out by the individual, the agent or anyone else to whom this task is assigned. This incentive to gain exposure inspires the individuals, and the fact that payment does not come until after the exposure has occurred reduces the financial risk to the sponsor of a sponsored individual who does not gain significant exposure.

### CROSS-REFERENCES TO RELATED APPLICATIONS

This application claims the benefit of U.S. Provisional Application No. 61/120,949 filed Dec. 9, 2008, which is hereby incorporated by reference.

### STATEMENT REGARDING FEDERALLY-SPONSORED RESEARCH AND DEVELOPMENT

(Not Applicable)

### REFERENCE TO AN APPENDIX

(Not Applicable)

### BACKGROUND OF THE INVENTION

1. Field of the Invention

This invention relates to methods of providing sponsorship dollars to those who perform in public environments.

2. Description of the Related Art

Athletes and others who compete or perform publicly require income in order to purchase equipment or pay entry fees for public events. Many athletes are paid by companies to wear or otherwise display decals, apparel, hats or other items bearing the companies' trademarks or other indicia. Such companies pay for their trademarks to be worn by the athletes because of the substantial public exposure the trademarks are likely to gain due to public interest in the athlete. For example, NASCAR racing vehicles bear many trademarks due to the high likelihood of the vehicle being filmed by television cameras broadcasting the race to racing fans. The vehicles bear the trademarks, because the companies are willing to pay fees to the vehicle's owner for the probability that their sponsored vehicle will be viewed by racing fans.

Unfortunately, other than a relatively few athletes in each sport, sponsorship by companies is difficult to achieve in athletic events due to the uncertainty that a given “unknown” athlete will gain public exposure. Even an excellent athlete must gain notoriety before he or she is “desirable” to a company interested in sponsoring an athlete. The apparent contradiction is that sponsors will not sponsor unknown athletes, but in order to become known, athletes need sponsorship funds. Other than a few stellar athletes, such as Michael Jordan, Tiger Woods and their peers, sponsorship hopes are lacking. Thus, the need exists for a way for unknown athletes and other public performers to obtain sponsorships.

### BRIEF SUMMARY OF THE INVENTION

The invention is a method of providing sponsorship to many people or entities, such as corporations or partnerships (natural people and corporations are collectively referred to herein as an “entity” or as “entities”). The method is especially advantageous for sponsored entities for which the amounts received are too small to justify the management of each individual sponsorship by the primary sponsor. For example, the sponsored entity could be a novice athlete who needs sponsorship money, but does not have a history of exposure, nor the projected exposure, that would justify a conventional sponsorship contract. The invention provides such minor entities the ability to benefit from corporate sponsorship, and provides sponsors with greater exposure and potential exposure at minimal up-front cost. Indeed, the fact that the only public exposure that the sponsor has to pay for is exposure that has already occurred removes the risk of little or no exposure by any pre-sponsored entity. Thus, all payments are for exposure after-the-fact, which is substantially the opposite of conventional sponsorship methods.

The method includes a first step of the sponsored entity (SE), such as an athlete or other performer, agreeing with the sponsor, or a managing agent who serves to arrange contracts between sponsors and SE's, regarding terms of the sponsorship. This could include, but is not limited to, executing a written sponsorship contract. The parties preferably prepare, negotiate and execute, such as by signing, a written contract. The sponsorship terms of the contract include, but are not limited to, the amount to be paid to the SE of public exposure, which amount is preferably based upon the number of potential viewers of the exposure and/or the demographics of such potential viewers. The sponsorship terms preferably state the value of particular types of exposure, for example in an appended or published schedule that is prepared in advance by the sponsor or the managing agent. The schedule could be the same for all SE's, or it could be different depending upon the degree to which exposure of the sponsor's indicia (discussed below) on a particular SE is advantageous to the sponsor.

Once the SE is in agreement regarding the terms, the sponsor, its agent or the managing agent preferably sends to the SE materials that the sponsor wishes to be exposed to the public by being placed on the SE's person. Such materials include, but are not limited to, apparel (hats, shirts, wristbands, headbands, vests, jackets, shorts, pants, socks and/or shoes), decals, patches, banners, flags and any other articles that bear the sponsor's desired indicia. Indicia include, but are not limited to, the sponsor's name, trademark, web page, telephone number and other source-indicating and/or promotional words, symbols, themes and characters. Alternatively, the sponsor does not send articles, but provides the SE with express permission to place indicia on his or her person. For the purposes of the invention, an SE places indicia on his or her person when the SE places indicia on his or her publicly exposed hair, skin, clothing, equipment, vehicle or in close proximity to the SE in a manner that the indicia could be exposed to the public. This would include banners or flags posted at the SE's unique area at a competition, for example a pit at an automobile race. This would also include holograms or other projected images of the indicia. In all cases, one essential step of the invention is that the SE places the indicia on his or her person, as those terms are defined herein.

One of the terms in the agreement between the sponsor and the SE is the provision that, if the indicia on the SE's person is exposed to the consuming public, in some way that can be demonstrated with persuasive evidence, then the sponsor will pay the SE a fee. Preferably, the fee is a function of the amount of exposure obtained, and is something that is not subject to serious doubt. This could be accomplished most readily by publishing or appending to the agreement a table showing the fee for exposure to predetermined size ranges of audiences, predetermined demographic audiences, etc. For example, if the indicia are displayed on the cover of Sports Illustrated, then the sponsor pays a fee based upon a schedule that includes the prominence of the display, circulation of the magazine, etc. If the indicia are displayed less prominently, such as in a small town newspaper, then the fee would be smaller. However, it is preferred that a previously agreed-upon schedule determines the fee that is to be paid, and the fee not be left up to the subjective judgment of a person.

In a preferred embodiment of the invention, the SE, or an agent, must communicate to the sponsor the evidence of the public exposure of the indicia. In the simplest form, this involves the SE physically mailing the photograph from a newspaper or magazine to the sponsor. In an alternative mode, the SE uploads a video or a hyperlink to a website set up by a managing company that processes such communications. Any manner of communicating the evidence to the sponsor or its agent is contemplated. The research for determining how the publicity fits into the schedule of fees can be performed by the SE, the sponsor or an agent. In any case, such submitted evidence should be processed and authorization to pay be granted, denied or otherwise dealt with.

The final step of the method is payment by the sponsor to the SE of the fee amount. This can take the form of mailing of a check, electronic transfer, deposit funds into an account the SE holds with the sponsor or an agent or any conventional manner of transferring consideration from one party to another. Alternatively, the fee can be “paid” by in-kind credit, services or goods from the sponsor.

It should be noted that the invention provides a person with the opportunity to earn sponsorship dollars based on the exposure he actually generates for the sponsor, not based upon the uncertain prospective exposure he anticipates receiving. Traditional sponsorship typically includes up-front payment by the sponsor with the “hope” of a return on its investment. As noted above, this includes the risk of complete failure by the sponsored entity, which results in substantial losses by the sponsor. The inventive method does not require up-front payments, even though it may include such payments as part of a payment plan, but it includes payments after the sponsor's logo or other promoted material has been displayed to the consuming public. This gives everyone an incentive to excel, which results in exposure and, therefore, payment by the sponsors. This also increases the competitiveness of the athletic event.

### BRIEF DESCRIPTION OF THE SEVERAL VIEWS OF THE DRAWINGS

FIG. 1 is a view in perspective illustrating a golfer wearing a sponsors indicia on his shirt.

FIG. 2 is a view in perspective illustrating a baseball glove bearing the indicia of a sponsor.

FIG. 3 is a view in perspective illustrating a musical performer playing a guitar bearing the indicia of a sponsor.

FIG. 4 is a side view illustrating a motorcycle bearing the indicia of a sponsor.

In describing the preferred embodiment of the invention which is illustrated in the drawings, specific terminology will be resorted to for the sake of clarity. However, it is not intended that the invention be limited to the specific term so selected and it is to be understood that each specific term includes all technical equivalents which operate in a similar manner to accomplish a similar purpose. For example, the word connected or term similar thereto are often used. They are not limited to direct connection, but include connection through other elements where such connection is recognized as being equivalent by those skilled in the art.

### DETAILED DESCRIPTION OF THE INVENTION

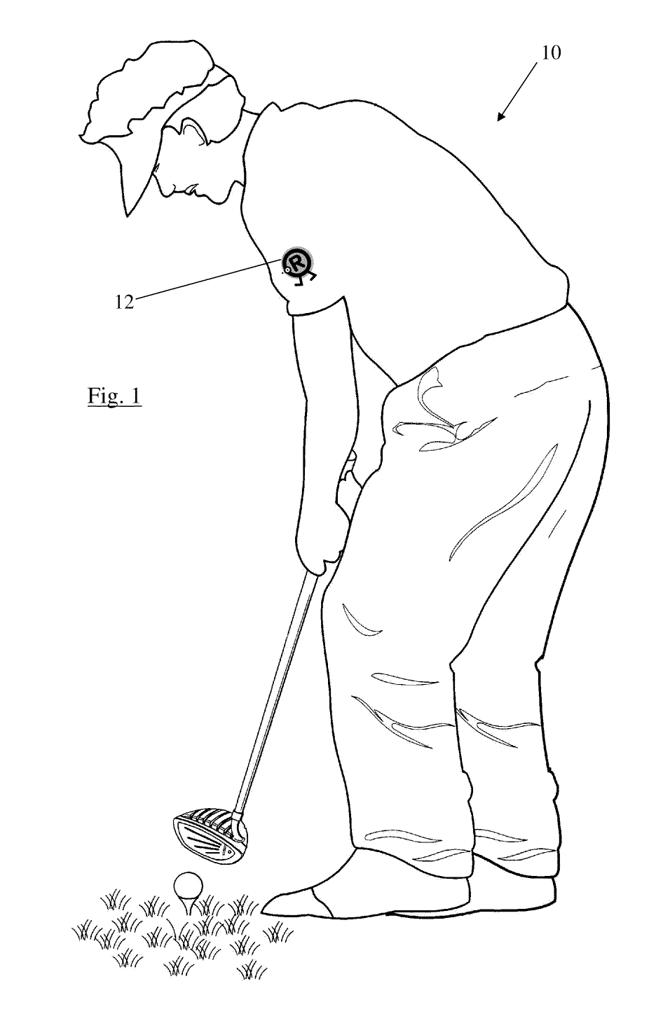

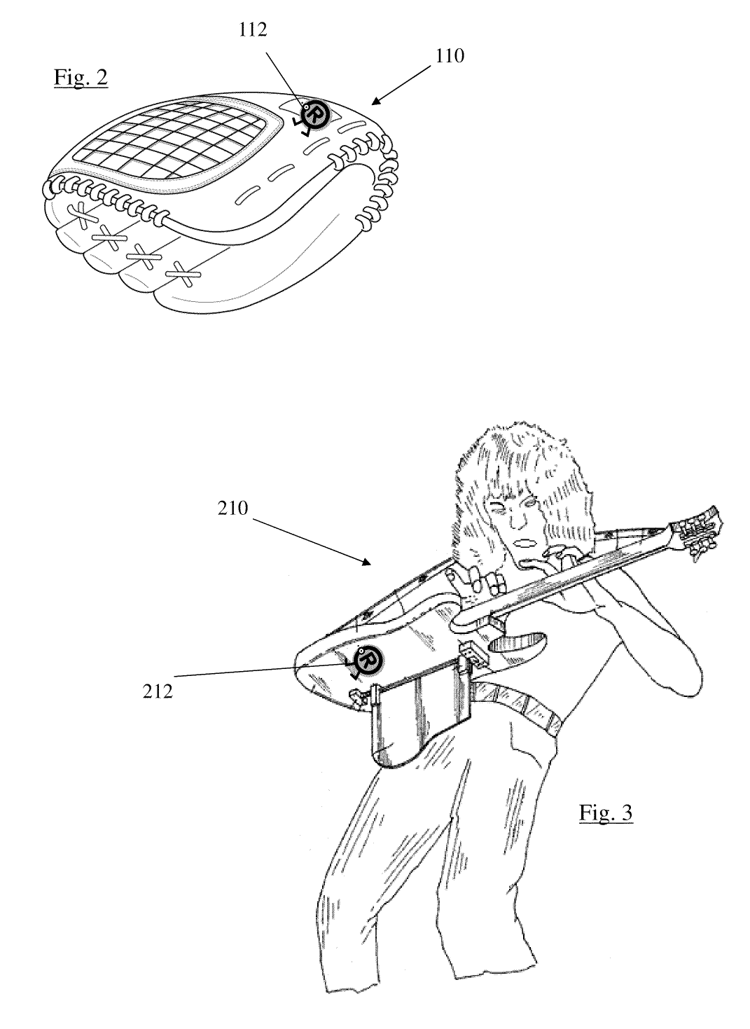

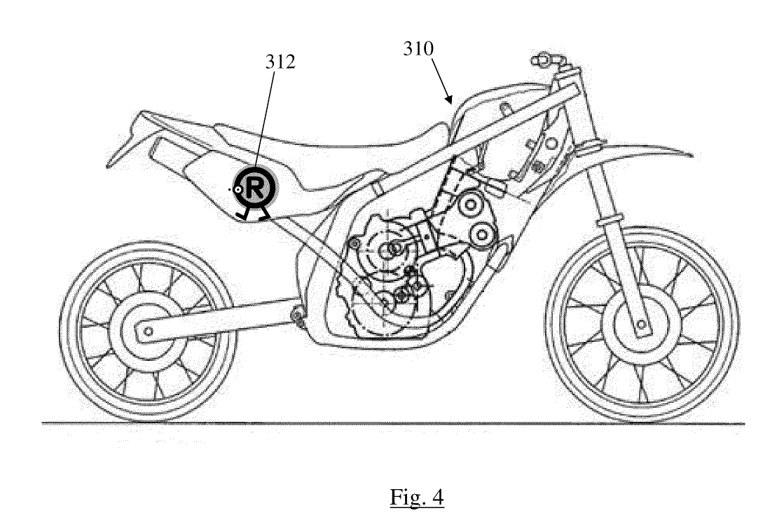

In one example of the invention, sponsor Company X participates in a program by providing funds and promotional materials (clothing, decals and other indicia representative of Company X) to a Management Company (MC). MC promotes the sponsorship opportunity to the public and enrolls sponsored entities (SE's), such as individuals, in the program. Each SE orders the promotional materials from the MC and places at least one indicium included in the promotional materials on his or her person or equipment. As an example, the SE can place the indicia on his shirt, as is shown in FIG. 1 in which a golfer 10 has indicium 12 attached to his shirt. If the golfer is closely followed by fans, the indicium will be seen by many people. It is possible a photograph of the golfer 10 will be published in a newspaper, in a magazine, online or on a television sports program. If so, the indicium can also be published. Another example is shown in FIGS. 2, 3 and 4, in which a baseball glove 110, guitarist 210 and motorcycle 310 bear indicia 112, 212 and 312, respectively. If any of these items is photographed, filmed or otherwise publicized, the SE associated with the item will be paid under the method of the invention.

It should be noted that a clever SE can devise ways of gaining publicity for the indicia, and does not have to have the indicia on his or her body to have it be considered on his or her “person”. For example, a banner placed at a finish line can be photographed by a journalist, and published, thereby paying off for the SE who placed the banner at the finish line.

The SE who placed the indicia, or whose equipment bears the indicia, attempts to gain exposure of the indicia through a multitude of media outlets including TV, print, radio, Internet, or any other conventional medium. This exposure of the indicia is publicity for Company X, and is valuable to Company X. Company X has thus agreed to pay the SE for any such exposure by the terms of a contract between the parties. For example, as a part of the order form to the MC to acquire the sponsor's indicia, the SE agrees to try to gain public exposure, and the MC agrees to pay SE (actually paid for by Company X) for any such exposure according to agreed-upon rates. If the order is placed online, the contract could be in the form of a “shrink-wrap” license on which the user “clicks” to indicate assent. Alternatively, a printed and signed agreement can be produced.

When the SE gains public exposure of the indicia, he or she provides evidence of the exposure to the MC for review, such as by submitting a photograph along with other evidence, to verify the exposure. The communication of the evidence is an important step in the process, but performance of this step is not limited to the SE. Indeed, this step can be performed by anyone, including the SE, the SE's agent, the sponsor, the sponsor's agent or an intermediary person or company. After the MC verifies Company X's indicia was publicized, MC pays SE according to the agreed-upon rates. In one embodiment, the MC forwards payment to the SE pursuant to the payment schedule determined by the value of such exposure, and invoices the sponsor (Company X) for the same.

It is, of course, possible to eliminate the MC and have sponsors who sponsor entities without any such “middleman”. Furthermore, it is not necessary that the SE be an athlete. Anyone who publicly performs in any way can be a sponsored entity, including, but not limited to, musicians, magicians, artists, journalists, publicists, spokesmen, politicians, salesmen and anyone else who obtains publicity for the sponsor's indicia.

This detailed description in connection with the drawings is intended principally as a description of the presently preferred embodiments of the invention, and is not intended to represent the only form in which the present invention may be constructed or utilized. The description sets forth the designs, functions, means, and methods of implementing the invention in connection with the illustrated embodiments. It is to be understood, however, that the same or equivalent functions and features may be accomplished by different embodiments that are also intended to be encompassed within the spirit and scope of the invention and that various modifications may be adopted without departing from the invention or scope of the following claims.

1. A method of a sponsor paying a sponsored entity for public exposure of the sponsored entity's indicia, the method comprising:
(a) the sponsored entity agreeing with the sponsor, or its agent, regarding terms of the sponsorship;
(b) the sponsor sending to the sponsored entity materials that bear desired indicia;
(c) the sponsored entity placing the indicia on his person;
(d) communicating to the sponsor tangible evidence of exposure of the indicia to a substantial portion of the public; and
(e) the sponsor paying a fee to the sponsored entity.

2. The method in accordance with claim 1, wherein the step of paying further comprises the step of calculating the fee based upon at least a characteristic of the exposure.

3. The method in accordance with claim 2, wherein the characteristic of the exposure is the number of people to whom the indicia was exposed.

4. The method in accordance with claim 2, wherein the characteristic of the exposure is the demographics of the people to whom the indicia was exposed.

5. The method in accordance with claim 2, further comprising the step of verifying the authenticity of the tangible evidence.

6. A method of a sponsor paying a sponsored entity for public exposure of the sponsored entity's indicia, the method comprising:
(a) the sponsored entity agreeing with the sponsor, or its agent, regarding terms of the sponsorship;
(b) the sponsor communicating to the sponsored entity permission to expose to the public desired indicia;
(c) the sponsored entity placing the desired indicia on his person;
(d) communicating to the sponsor tangible evidence of exposure of the indicia to a substantial portion of the public; and
(e) the sponsor paying a fee to the sponsored entity.

7. The method in accordance with claim 6, wherein the step of paying further comprises the step of calculating the fee based upon at least a characteristic of the exposure.

8. The method in accordance with claim 7, wherein the characteristic of the exposure is the number of people to whom the indicia was exposed.

9. The method in accordance with claim 7, wherein the characteristic of the exposure is the demographics of the people to whom the indicia was exposed.

10. The method in accordance with claim 7, further comprising the step of verifying the authenticity of the tangible evidence.
